(19) United States
(12) Patent Application Publication
(10) Pub. No.: US 2024/0149406 A1
(43) Pub. Date: May 9, 2024

(54) ELECTRIC PRECISION SCREWDRIVER

(71) Applicant: Shenzhen Fanttik Technology Innovation Co., Ltd., Shenzhen (CN)

(72) Inventor: Feng Wang, Shenzhen (CN)

(21) Appl. No.: 18/380,676

(22) Filed: Oct. 17, 2023

(30) Foreign Application Priority Data
Nov. 9, 2022 (CN) 202211395462.9

(51) Int. Cl. B25B 21/00; B25B 23/00

(52) U.S. Cl. CPC B25B 21/00; B25B 23/0035

(57) ABSTRACT

An electric precision screwdriver includes: a hollow housing; a hollow retainer received in and detachably connected to the housing; a main body received in the retainer, and detachably connected to the retainer or the housing, the main body comprising an exposed end; and a charging port arranged in the exposed end of the main body. The retainer is to receive a pushing force from a user so as to disconnect the retainer from the housing, and disconnect the main body from the retainer or the housing.

### CROSS REFERENCE TO RELATED APPLICATIONS

The present application claims priority to Chinese Patent Application No. 202211395462.9, filed Nov. 9, 2022, which is hereby incorporated by reference herein as if set forth in its entirety.

### TECHNICAL FIELD

The present disclosure generally relates to electric screwdrivers, and particularly to an electric screwdriver having an ejection mechanism.

### BACKGROUND

A screwdriver is a hand-held tool used for turning screws and bolts. Since the process of turning screws/bolts is a repetitive mechanical movement, people now generally use electric screwdrivers to complete this process. For the convenience of operation, some electric screwdrivers can be recharged to increase their portability.

Although the conventional electric screwdrivers can meet basic requirements, it is still useful and desirable to provide a new electric screwdriver.

### BRIEF DESCRIPTION OF DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a front view of the electric precision screwdriver in a first state.

FIG. 2 is a side view of the electric precision screwdriver in the first state.

FIG. 3 is a cross-sectional view of the electric precision screwdriver in the first state.

FIG. 4 is a front view of the electric precision screwdriver in the second state.

FIG. 5 is a cross-sectional view of the electric precision screwdriver in the second state.

FIG. 6 is a front view of the electric precision screwdriver in the third state.

FIG. 7 is a cross-sectional view of the electric precision screwdriver in the third state.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one” embodiment.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

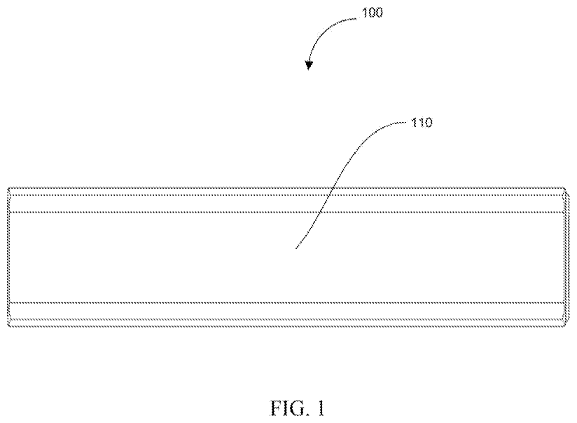

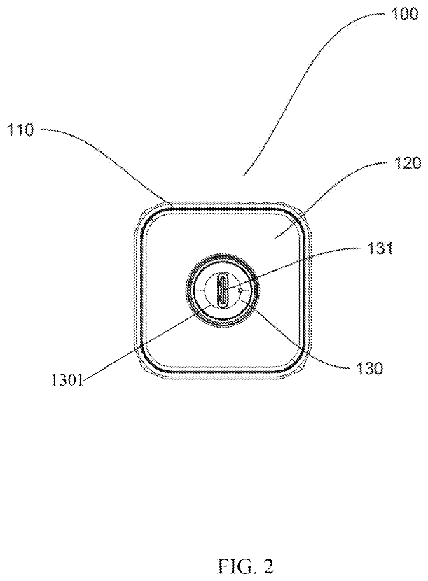

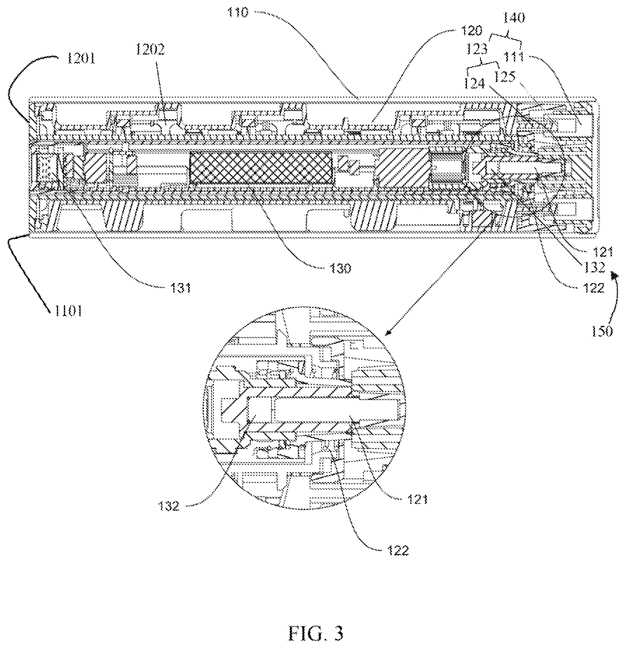

Referring to FIGS. 1-3, in one embodiment, an electric precision screwdriver 100 includes a hollow housing 110, a hollow retainer 120 and a main body 130. The main body 130 is the main working part of the electric precision screwdriver 100, which can cooperate with various screwdriver bits to turn screws/bolts to mount and disassemble parts/components. The retainer 120 can not only serve as a storage container for the main body 130, but also can store a variety of screwdriver bits to facilitate a user's normal use and replacement of screwdriver bits. FIG. 1 is a front view of the electric precision screwdriver in a first state. FIG. 2 is a side view of the electric precision screwdriver in the first state. FIG. 3 is a cross-sectional view of the electric precision screwdriver in the first state.

In one embodiment, the main body 130 has an exposed end 1301 that is external to the retainer 120. A charging port 131 (e.g., a USB Type-C port) is arranged in the exposed end 1301. With such configuration, when the main body 130 is fully received in the retainer 120, it can still be charged. This can avoid the problem that some conventional electric screwdrivers need to be taken out of a storage case before charging. When a user attempts to charge the main body 130, there is no need to take out the main body 130, so that the user's operating object during charging is limited to the entire electric precision screwdriver 100. There is no need to consider the position of the removed housing 110 or the retainer 120, and the main body 130 can be charged directly in its storage state.

In one embodiment, the charging port 131 can be selected from other types of interfaces, such as Micro USB, Lightning and other interfaces. In another embodiment, multiple charging ports 131 can be employed so as to adapt to different charging environments.

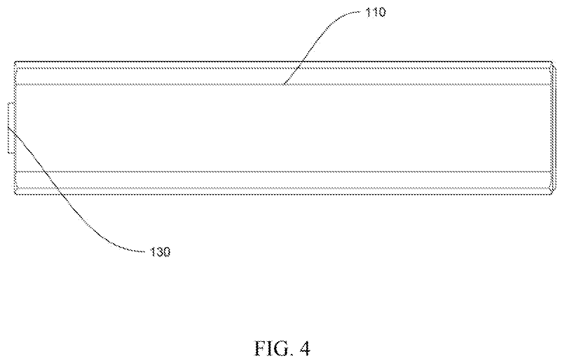

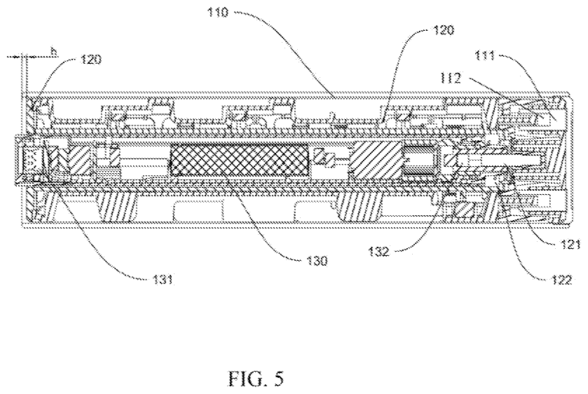

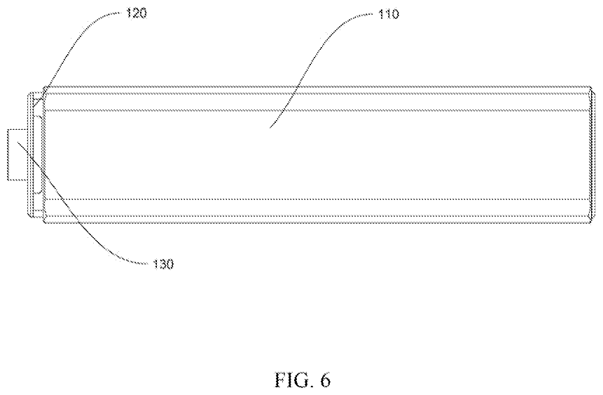

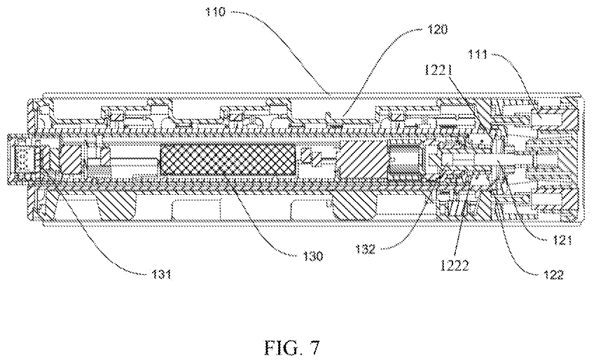

In one embodiment, the electric precision screwdriver 100 can be in at least three states, namely the first state, the second state and the third state. The second state is an intermediate state between the first state and the third state. FIGS. 1-3 are schematic diagrams of the electric precision screwdriver in the first state. FIG. 4 is a front view of the electric precision screwdriver in the second state, and FIG. 5 is a cross-sectional view of the electric precision screwdriver in the second state. FIG. 6 is a front view of the electric precision screwdriver in the third state, and FIG. 7 is a cross-sectional view of the electric precision screwdriver in the third state.

Specifically, the first state is the storage state. In the storage state, the main body 130 is received in the retainer 120, and the retainer 120 is stored in the housing 110. That is, the main body 130 and the retainer 120 are completely received in the housing 110, so that the entire electric precision screwdriver is of a columnar shape, which is convenient for a user to store and handle. Meanwhile, the retainer 120 and the main body 130 are protected. Referring to FIG. 3, in the first state, the exposed end 1301 of the main body 130, the open end 1201 of the retainer 120 and the open end 1101 of the housing 110 are flush with one another.

The second state is the intermediate state. In the second state, the main body 130, the retainer 120, and the housing 110 are in the process of being disconnected from each other. In this case, not only the retainer 120 is being disconnected from the housing 110, but the main body 130 is being disconnected from the retainer 120 or the housing 110.

The third state is the completely disconnected state. In the third state, the main body 130 is completely disconnected from the retainer 120 or the housing 110. The retainer 120 is completely disconnected from the housing 110. In this case, a user can freely move the main body 130 and/or the retainer 120.

In one embodiment, the electric precision screwdriver 100 further includes a first connection mechanism 140 (see FIG. 3), a second connection mechanism 150 (see FIG. 3) and an elastic member 122. The first connection mechanism 140 is configured to detachably connect the retainer 120 to the housing 110. The second connection mechanism is configured to detachably connect the main body 130 to the retainer 120 or the housing 110. The elastic member 122 is arranged between the main body 130 and the retainer 120 and is configured to apply a pushing force to the main body 130.

The first connection mechanism 140 is configured to apply a pushing force to the retainer 120 when the retainer 120 is moved into the housing 110 by a pushing force from a user, so as to push the retainer 120 to move out of the housing 110 after the pushing force from the user disappears. The elastic member 122 is configured to push the main body 130 to move out of the retainer 120 when the retainer 120 moves out of the housing. Thus, a user can apply a pushing force to the retainer 120 to move it into the housing 110, and then release the retainer 120 to disconnect the retainer 120 from the housing 110 and disconnect the main body 130 from the retainer 120 or the housing 110. Then, the user can freely move the main body 130 and/or the retainer 120. The above-mentioned components and their connection relationships will be described in detail below.

In one embodiment, the housing 110 is a hollow cylinder with an opening at one end and a closed end at the other end. In the first state, one end of the retainer 120 is detachably connected to the closed end of the housing 110, and one end of the main body 130 is received in and detachably connected to the retainer 120. In an alternative embodiment, the end of the main body 130 may pass through the retainer 120 and may be detachably connected to the housing 110. The charging port 131 is arranged in the exposed end 1301 of the main body 130.

In one embodiment, the first connection mechanism 140 may include a post 123 arranged on the retainer 120 and an elastic engagement member 111 arranged in the housing 110. The engagement member 11 defines a receiving hole 112 (see FIG. 5), and the post 123 is tightly fit in the receiving hole 112, which detachably connects the retainer 120 to the housing 110.

In one embodiment, the post 123 includes a shank 124 and a head 125 formed on an end of the shank 124. The diameter of the head 125 is larger than the diameter of the shank 124. The head 125 is tightly fit in the receiving hole 112. In one embodiment, the receiving hole 112 may include a first hole and a second hole. The diameter of the first hole is greater than the diameter of the second hole, and a step surface is formed at the position where the first hole and the second hole join. The head 125 is tightly fit in the first hole. When the retainer 120 is pushed by a user and moves into the housing 110, the head 125 will come into contact with the step surface and exert a pushing force on it, and the elastic engagement member 111 will be elastically deformed by the pushing force. After the external force exerted by the user disappears, the elastic engagement member 111 rebounds and exerts a pushing force the retainer 120. The retainer 120 can thus be pushed to move out of the housing 110.

In one embodiment, the retainer 120 defines a chamber 1202 for receiving the main body 130. The second connection mechanism 150 includes an attracting member 121 arranged in the chamber 1202 and a magnet 132 arranged on one end of the main body 130 located in the retainer 120. The main body 130 is connected to the retainer 120 through the magnetic attraction force between the attracting member 121 and the magnet 132. The attracting member 121 can be a metal rod aligned with the magnet 132. The elastic member 122 is arranged around the attracting member 121. One end 1221 (see FIG. 7) of the elastic member 122 is connected to the retainer 120, and the other end 1222 (see FIG. 7) abuts against the main body 130. In one embodiment, the elastic member 122 is a coil spring. One end of the coil spring is connected to the retainer 120, and the other end abuts against the main body 130. The coil spring is arranged around the magnet 132.

In another embodiment, the magnet may be located in the retainer, and the attracting member may be provided on the post. In other words, the positions of the magnet and the attracting member can be exchanged.

In another embodiment, one of the magnet 132 and the attracting member 121 may be arranged on the main body 130, and the other of the magnet 132 and the attracting member 121 may be arranged in the housing 110. In this case, the retainer 120 may include two open ends such that the attracting member 121 can pass through one open end of the retainer 120 and can be magnetically attracted to the magnet 132, which connects the main body 130 to the housing 110.

In one embodiment, in the first state and the second state, the elastic member 122 is always in a compressed state and exerts a pushing force on the main body 130 that points toward the left in FIGS. 3 and 5. In the first state, the attracting member 121 and the magnet 132 are magnetically attracted to each other, and the attraction force between them is maximum. The main body 130 is connected to the retainer 120 under the action of attraction force. Meanwhile, the main body 130 presses the elastic member 122 so that the elastic member 122 is in a compressed state.

The second state corresponds to the user pressing the retainer 120 to move it a distance h in the first state. Specifically, the retainer 120 will first move a distance h to the right relative to the housing 110. When the external force from a user disappears, the elastic engagement member 11I rebounds to drive the retainer 120 to move to the left, so that the retainer 120 can be disconnected from the housing 110. In one embodiment, h is preferably between 20 mm and 220 mm. Regarding the retainer 120 and the main body 130, the retainer 120 is pressed, causing the attracting member 121 of the retainer 120 to move accordingly, so that the attracting member 121 is out of contact with the magnet 132. The attraction force between the magnet 132 and the attracting member 121 is thus reduced. At this time, the main body 130 moves and compresses the elastic member 122, causing the elastic pushing force on the main body 130 to be greater than the attraction force on the main body 130. The elastic member 122 begins to rebound, and the main body 130 is driven by the elastic member 122 to move a certain distance toward the open end of the retainer 120. After that, the electric precision screwdriver is in the third state as shown in FIG. 7.

For the electric precision screwdriver 100 as a whole, the user only presses the retainer 120, and as a result, the retainer 120 is disconnected from the housing 110 and is ejected to move outward a certain distance, and the main body 130 is disconnected from the retainer 120 or the housing 110 and it ejected to move outward a certain distance. In other words, with only one press operation, the housing 110, the retainer 120 and the main body 130 are disconnected from each other, which greatly increases the simplicity of the operation.

Since the charging port 131 is located at the exposed end 1301 of the main body 130, a user may touch the charging port 131 if he/she directly presses the main body 130. The sweat from the user's finger or small particles attached to the user's finger may enter the charging port 131, which may affect the normal operation of the charging port 131 and even affect its service life. In addition, the end of the main body 130 located in the retainer 120 is provided with a bit receiver, which needs to ensure tight connection with screwdriver bits. If the main body 130 is pressed, the main body 130 first moves inward, and needs to move to drive the retainer 120 to a predetermined position to trigger the unlocking process. This may cause the bit receiver to deform due to pressure, which in turn affects the connection between the bit receiver and screwdriver bits. By contrast, the electric precision screwdriver 100 adopts a special method, so that the action of pressing the retainer 120 simultaneously realizes the action of ejecting the main body 130 and disconnecting the housing 110. When the retainer 120 is pressed, no excessive external force is applied to the main body 130, which is beneficial to maintaining the accuracy and service life of the electric precision screwdriver 100.

In another embodiment, the charging port of the main body is defined on the lateral surface of the main body. At the same time, an opening is defined in each of the lateral surface of the housing and the lateral surface of the retainer for the plug of a charger to be inserted into the charging port. The openings are shaped and sized according to the shape and size of the charging port. As a result, when the main body has not been fully stored and reached the predetermined position, the openings are not aligned with the charging port and the main body cannot be charged. This can be used as an indicator of whether the main body is fully stored, and can prevent direct charging when the main body is not fully stored, causing it to fall from the retainer or the housing.

In another embodiment, the closed end of the housing is provided with a baffle wall or block that penetrates the retainer. The baffle wall or block will not hinder the movement of the retainer. The baffle wall or block is to prevent the main body from following the movement of the pressed retainer, thereby ensuring that the magnetic attraction between the main body and the retainer/housing is reliably overcome when the retainer is pressed, thereby realizing automatic ejection of the main body.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. An electric precision screwdriver comprising:
a hollow housing;
a hollow retainer received in and detachably connected to the housing;
a main body received in the retainer, and detachably connected to the retainer or the housing, the main body comprising an exposed end; and
a charging port arranged in the exposed end of the main body;
wherein the retainer is configured to receive a pushing force from a user so as to disconnect the retainer from the housing, and disconnect the main body from the retainer or the housing.

2. The electric precision screwdriver of claim 1, further comprising a magnet and an attracting member, wherein the retainer defines a chamber to receive the main body, the magnet is arranged on an end of the main body that is located in the retainer, the attracting member is mounted on the retainer or the housing, the attracting member is magnetically attracted to the magnet, which detachably connects the main body to the retainer or the housing.

3. The electric precision screwdriver of claim 2, wherein the attracting member is a metal rod aligned with the magnet.

4. The electric precision screwdriver of claim 2, further comprising an elastic member arranged around the attracting member.

5. The electric precision screwdriver of claim 4, wherein the elastic member is compressed when the main body is received in the retainer.

6. The electric precision screwdriver of claim 5, wherein the elastic member comprises a first end attached to the retainer, and an opposite second end abutting against the main body.

7. The electric precision screwdriver of claim 6, wherein the elastic member is a coil spring.

8. The electric precision screwdriver of claim 1, wherein the retainer and the housing each comprise an open end, the exposed end of the main body and the open ends of the retainer and the housing are flush with one another when the main body is received in the retainer and the retainer is received in the housing.

9. An electric precision screwdriver comprising:
a hollow housing;
a hollow retainer received in the housing;
a main body received in the retainer;
a first connection mechanism configured to detachably connect the retainer to the housing;
a second connection mechanism configured to detachably connect the main body to the retainer or the housing;
an elastic member arranged between the main body and the retainer, the elastic member configured to apply a pushing force to the main body;
wherein the first connection mechanism is configured to apply a pushing force to the retainer when the retainer is moved into the housing by a pushing force from a user, so as to push the retainer to move out of the housing after the pushing force from the user disappears;
wherein the elastic member is configured to push the main body to move out of the retainer when the retainer moves out of the housing.

10. The electric precision screwdriver of claim 9, wherein the second connection mechanism comprises a magnet and an attracting member, the retainer defines a chamber to receive the main body, the magnet is arranged on an end of the main body that is located in the retainer, the attracting member is mounted on the retainer or the housing, the attracting member is magnetically attracted to the magnet, which detachably connects the main body to the retainer or the housing.

11. The electric precision screwdriver of claim 9, wherein the attracting member is a metal rod aligned with the magnet.

12. The electric precision screwdriver of claim 10, further comprising an elastic member arranged around the attracting member.

13. The electric precision screwdriver of claim 12, wherein the elastic member is compressed when the main body is received in the retainer.

14. The electric precision screwdriver of claim 13, wherein the elastic member comprises a first end attached to the retainer, and an opposite second end abutting against the main body.

15. The electric precision screwdriver of claim 14, wherein the elastic member is a coil spring.

16. The electric precision screwdriver of claim 9, wherein the retainer and the housing each comprise an open end, the exposed end of the main body and the open ends of the retainer and the housing are flush with one another when the main body is received in the retainer and the retainer is received in the housing.

17. The electric precision screwdriver of claim 9, wherein the first connection mechanism comprises a post arranged on the retainer and an elastic engagement member arranged in the housing, the engagement member defines a receiving hole, and the post is tightly fit in the receiving hole.

18. The electric precision screwdriver of claim 17, wherein the post comprises a shank and a head formed on the shank, and the head is tightly fit in the receiving hole.
